(19) United States
(12) Patent Application Publication
(10) Pub. No.: US 2002/0169726 A1
(43) Pub. Date: Nov. 14, 2002

(54) System and product for pervasive commerce

(76) Inventors: Mark S. Taylor, Sammamish, WA (US); David C. Morse, Sammamish, WA (US); Joseph Zipperer, Seattle, WA (US); George P. Lightbody, Seattle, WA (US)

Correspondence Address: BLACK LOWE & GRAHAM, 816 SECOND AVE., SEATTLE, WA, 98104, US

(21) Appl. No.: 09/852,390

(22) Filed: May 9, 2001

(51) Int. Cl. H04K 1/00

(52) U.S. Cl. 705/64

(57) ABSTRACT

A system and computer program product for exchanging information while offline (not connected to a networked infrastructure), modifying the information and using it to generate commercial transactions that can be subsequently fulfilled by sellers. A case and associated processes allow for commerce that can occur at anytime and anyplace. A case contains sufficient information to permit the purchase of any of a wide variety of products and services. The case structure provides the ability for producers, distributors and consumers to independently insert information describing the subject item. Subsequent receivers of the case read the comments and information inserted by previous holders of the case. Cases also can contain any of a variety of digital objects, such as digital recordings of music, images, video or other media. A digital object contained by a case may itself be the subject of the case or a sample of the subject item. Also, a case can contain a commercial item as well as a description of the commercial item.

### FIELD OF THE INVENTION

This invention relates to mechanisms for distributing both information about items and digital assets.

### BACKGROUND OF THE INVENTION

There are three sales “channels” currently available to retailers—retail, catalog and website. Commercial activity must take place on one of those channels, which limits the commercial activity by time or location or both. A consumer might purchase a product or service while in a retail establishment, but this limits the consumer activity by time and location. The consumer might also purchase a product or service via the Internet, but this limits their activity to locations and times that they can be on-line. Finally, a consumer might purchase a product or service from a catalog via the telephone, but this again limits their activity to certain locations and times, and requires the consumer to know what they want from the catalog (i.e., this mode of commerce discourages browsing).

Although the phrase “it sells itself” is often used to describe a product or service, it is currently impossible for an item to truly sell itself. Information about the product, its cost, where it can be acquired, etc., is not readily available from products themselves. Some kind of external agent or mechanism is always required to enable the purchase of an item.

### SUMMARY OF THE INVENTION

The present invention describes a set of mechanisms for exchanging information while offline (not connected to a networked infrastructure), modifying the information and using it to generate commercial transactions that can be subsequently fulfilled by sellers. In particular, this invention describes the data objects and processes necessary for pervasive commerce (i.e., commerce that can occur at anytime and anyplace). Although this invention is specifically aimed at supporting offline commerce, it may be generally used in support of any information exchange between parties.

The present invention utilizes software data objects, called cases, for performing off an online commerce. Cases and the processes that operate on them provide certain capabilities necessary for pervasive commerce, including:

Support for a variety of items and uses

Ability to contain any of a variety of digital objects

Tamper-resistant as the cases are “passed” around

Support for multiple sales levels with commissions

Capability for “mutation” as the cases are “passed” around

Ability to be customized and have specific features selected

Ability to be location-limited in their use

Ability to be tracked as the cases are “passed” around

Provision for non-repudiation by their users

Support for multiple device types

Flexibility while requiring minimum resources.

Generally, cases contain information about items. In particular, cases contain sufficient information to permit the purchase of any of a wide variety of products and services. The case structure provides the ability for a number of parties—for example, producers, distributors and consumers—to independently insert information describing the subject item. Subsequent receivers of the case can read the comments and information inserted by previous holders of the case.

In addition to containing information about items, cases can contain any of a variety of digital objects, such as digital recordings of music, images, video or other media. A digital object contained by a case may itself be the subject of the case or a sample of the subject item. Thus, a case may contain a commercial item as well as a description of one or more commercial items.

Because cases can be used for commercial purposes, they are tamper resistant to preserve the integrity of their contents. As a case is passed between parties, each of which may enter information about the subject item, certain information elements within the case remain invariant. Subsequent receivers of the case can verify its integrity by means of a chain of digital signatures placed in the case by earlier receivers of the case.

Cases provide the ability for one party to sell the subject item to a second party, who can then sell the item to a third party and so on. At each sales level, the selling party can modify the current selling price in support of their commercial goals. This provides the ability for parties at earlier levels to receive commissions or “spiffs” as the case is passed and purchases generated from it.

Cases are capable of mutation as they are passed from one party to another. Based on rules, such as the date or number of times the case has been passed, the case and the manner in which it may be used can mutate. For example, a retailer could exploit this capability to offer time-limited discounts via the pervasive commerce sales channel.

Subject to the mutation and tamper resistance capabilities it enjoys, a case may be customized and have specific features selectable by any party. For example, a case might represent an article of clothing, with customization (i.e., the appropriate size and color desired by a consumer).

Cases are restricted in their commercial use in terms of where and how they may be employed. For example, a case could be used as a digital “coupon” that is exercisable only within a specific retail location.

Cases are tracked as they are passed around by application software designed for this purpose by combining information contained within the case and case passing notifications sent to the Managing Entity.

Cases provide a mechanism for non-repudiation by parties exercising them. This allows cases to be used as the medium for conducting pervasive commerce, e.g., a person purchasing an item via a case cannot subsequently deny having made the purchase.

The structure of a case is platform-independent and not restricted to any particular device or operating system platform or combination thereof. A case is passed from one party to another regardless of the type of device that each party employs. In particular, cases may be received, stored, passed and exercised by a variety of devices, creator servers, distributor servers and managing entity servers.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the domain of pervasive commerce, including the devices, entities and systems employed therein;

FIG. 2 illustrates the most general form of case layout;

FIG. 3 illustrates a case layout that is specific to pervasive commerce;

FIG. 4 illustrates the flow of a case and its derivative data structures from case creator to consumer;

FIG. 5 illustrates the layout of the case template constructed by the case creator;

FIG. 6 illustrates the layout of a case prime maintained by the managed entity;

FIG. 7 illustrates the layout of a user case that is passed from a passer to a receiver;

FIG. 8 illustrates the layout of a complete case;

FIG. 9 illustrates the steps for synchronizing a consumer PDA with a managing entity;

FIG. 10 illustrates the steps taken when a consumer makes a case-based purchase;

FIG. 11 illustrates a data structure used for a purchase request;

FIG. 12 illustrates the steps taken when a case is passed between sales associates;

FIG. 13 illustrates the steps taken when a case is passed from a sales associate to a consumer;

FIG. 14 illustrates the steps taken when a case is passed between consumers;

FIG. 15 illustrates the structure of a case wherein all information about the case is maintained within the case;

FIG. 16 illustrates an exchange of a public key from a receiver to a passer followed by a case being passed from the passer to the receiver;

FIG. 17 illustrates an exchange of a random public key selected by a passer followed by a case being passed from the passer to the receiver;

FIG. 18 illustrates the contents of a digital object;

FIG. 19 illustrates a trusted case mutation process; and

FIG. 20 illustrates an untrusted case mutation process.

### DETAILED DESCRIPTION OF THE PREFERRED EMBODIMENT

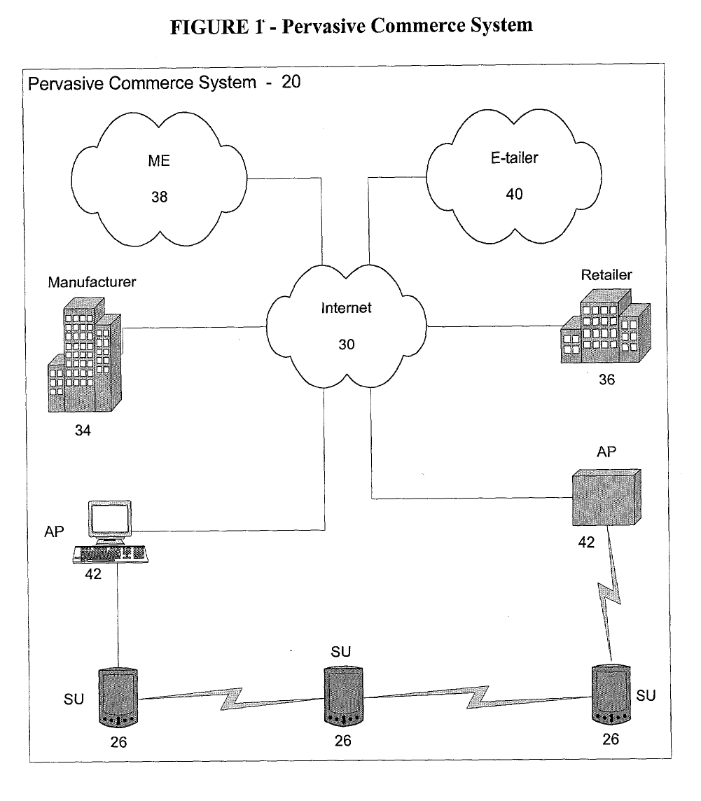

The present invention requires a system 20 that includes a collection of collaborating participants and software application entities coupled with the necessary means of communicating among the various parties, as illustrated in FIG. 1. Among the entities are a Managing Entity (ME 38) 38 that is responsible for managing and maintaining the system 20 and a variety of producers (manufacturers) 34, sellers (retailers) 36 and consumers, all interconnected via an internetwork 30. Sales associates that interface between sellers and consumers are also supported by the pervasive commerce model.

Two or more parties (consumers or sales associates) exchange information between their station units (SUs) 26, which may take the form of personal digital assistants, cellular telephones, portable computers or other portable computing devices with wireless communications capability. The exchange of information can lead to a subsequent offline purchase transaction by the receiver of the information. The offline purchase transaction is later completed via access points (APs) 42 that allow the SUs 26 to interact with the rest of the system 20.

### Case Contents and Structure

The primary function of a case structure is to provide the necessary electronic information to enable the exchange of information between two parties who are offline (not connected to the network 30) for the express purpose of pervasive commerce. This end goal determines the required capabilities and features and therefore the definition of the case structure.

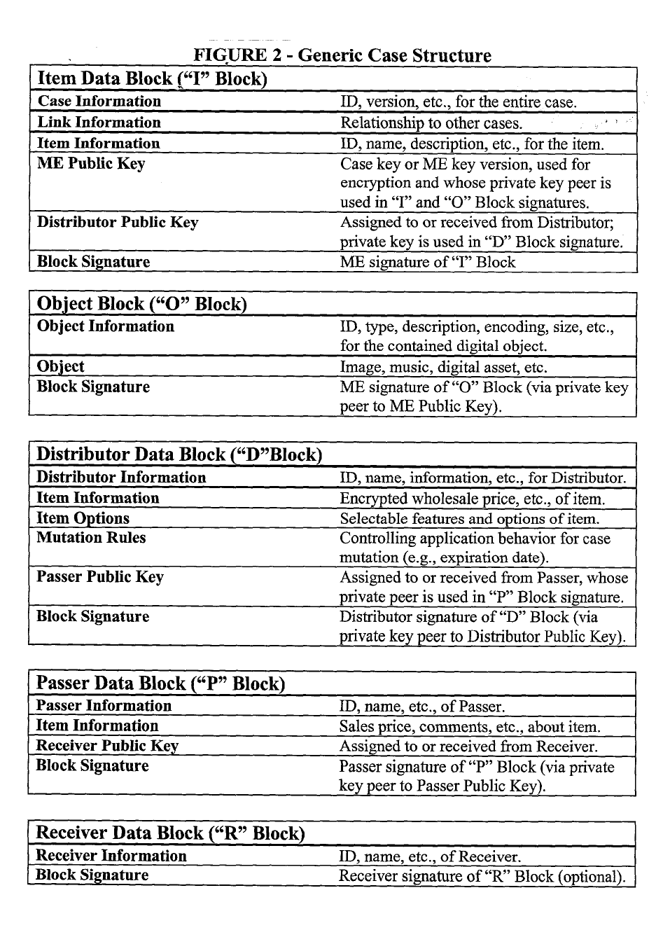

FIGS. 2A-E depict data components of a case in its most general form. The case includes five blocks 62-68 of information, each of which serves a distinct function. All blocks appear once in a case with the exception of a penultimate block, which may appear multiple times. The blocks 62-68 reflect the contributions made to the case by the various pervasive commerce participants, generalized as Case Creator, ME 38, Case Distributor, Case Passer and Case Receiver.

The Case Creator or Creator is the entity that initiates the creation of a case; typically, this is a producer 34 of a good or service. The ME 38 is the entity responsible for managing the pervasive commerce system 20. The Case Distributor or Distributor is the entity responsible for the initial distribution of cases; typically, this is a seller 36 of a good or service. The Case Passer or Passer is the entity that after obtaining a case spreads the obtained case around by passing it to others. The Case Receiver or Receiver is the entity that the Passer passes the case to. A typical consumer can be either a Passer or a Receiver depending on whether it is sending or receiving cases.

An Item Data (I) Block 60 includes case information that applies to the subject item and the case itself. Case Information includes a globally unique identifier for the case, its version (if there are multiple versions of the case data structure) and other information needed by devices and systems to interact with the case. The I Block 60 includes link Information that describes the case's relationship to other cases for data inheritance and other purposes. Also included in the I block 60 is item information that includes an identifier, name and description of the subject item, as defined by the producer 34 of the subject item. Item Information can also include comments about the item from the producer 34.

Information elements encrypted using a ME 38 Public Key can be decrypted (only) by the ME 38. The ME 38 Public Key can therefore be used to verify the digital signatures of the I Block 60 and an Object (O) Block 62, which are signed by the ME 38. The ME 38 Public Key can also be used to encrypt information elements that are targeted for (only) the ME 38. Information elements encrypted using a Distributor Public Key can be decrypted (only) by the Distributor. The Distributor Public Key therefore can be used to verify the digital signature of Distributor Data (D) Block 64, which is signed by the Distributor. The I Block 60 is signed by the ME 38 via a hashing/digest technique, such as MD5, coupled with a public key cryptosystem, such as PGP or RSA.

The O Block 62 contains a digital object and information describing it. The O Block 62 includes Object Information that includes an identifier, name, description, encoding type and length of the digital object. Also included in the O Block 62 is Object that is the object itself, which can be any digital representation of music, image, video, etc. Digital rights management functions are embodied within the object itself. Anyone (i.e., Case Creator, ME 38, Distributor) can insert an object into the case by means of an O Block 62. The O Block 62 is signed by the ME 38 via a hashing/digest technique, such as MD5, coupled with a public key cryptosystem, such as PGP or RSA; the mechanism for signing the O Block 62 is not necessarily the same as that for the I Block 60.

A Distributor Data (D) Block 64 contains information about the Distributor and about a subject item from the perspective of the Distributor. Distributor Information contains an identifier, name and descriptive information for the Distributor, who is typically the seller (e.g., retailer) of an item sold in a pervasive commerce setting. D Block 64 includes Item Information that contains information about the subject item that the Distributor wishes to insert into the case, such as wholesale/retail price information, which may be encrypted, or comments about the subject item. Also included in D Block 64 is Item Options that contain information about the subject item that is specific to the Distributor, such as sizes, colors or other characteristics that are selectable by the possessor of the case. D Block 64 also includes Mutation Rules that contain control information for case mutation, such as expiration dates for sales, etc. Information elements encrypted using the Passer Public Key are decrypted (only) by the Passer of the case; the Passer Public Key can therefore be used to verify the digital signature of a Passer Data (P) Block 66, which is signed by the Passer. The D Block 64 is signed by the Distributor via a hashing/digest technique, such as MD5, coupled with a public key cryptosystem, such as PGP or RSA.

The P Block 66 contains information about the subject item from the perspective of the party that is passing the case to another. P Block 66 includes Passer Information that includes information about the Passer, such as the identifier and name of the Passer. Also included in P Block 66 is Item Information that includes information about the subject item, including the sales price offered by the Passer (if relevant) or comments about the subject item from the Passer. Information elements encrypted using the Receiver Public Key can be decrypted (only) by the Receiver of the case. The Receiver Public Key can therefore be used to verify the digital signature of a Receiver Block (R) Block 68. The P Block 66 is signed by the Passer via a hashing/digest technique, such as MD5, coupled with a public key cryptosystem, such as PGP or RSA. The P Block 66 may appear multiple times in a case.

The R Block 68 contains information about the Receiver of the case. R Block 68 includes Receiver Information that contains the identifier and name of the Receiver. The R Block 68 may optionally be signed by the Receiver via a hashing/digest technique, such as MD5, coupled with a public key cryptosystem, such as PGP or RSA.

Once a Receiver SU 26 has stored the case, it can become a Passer of the stored case. Prior to passing the case, however, the SU 26 must update the case to reflect that the SU 26 is now the Passer by adding or replacing a P Block 66, as described later.

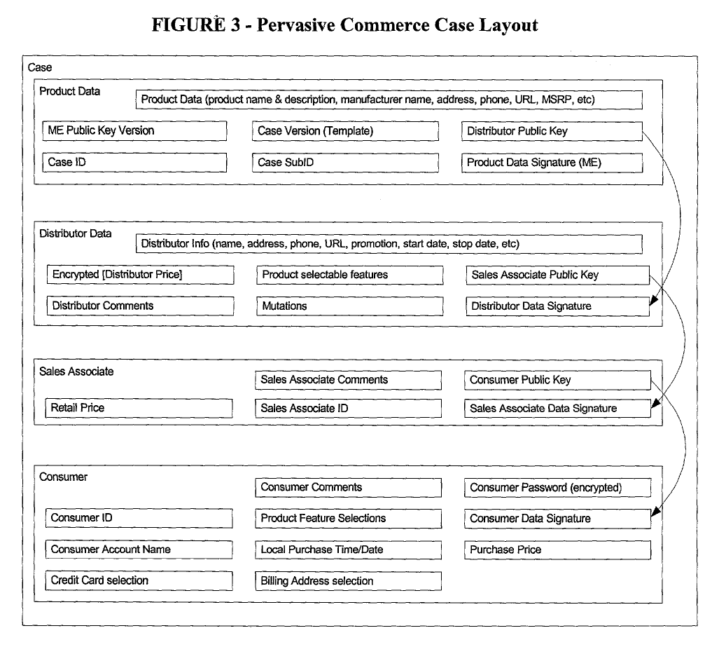

FIG. 3 depicts the layout for a case that is used specifically for pervasive commerce but does not contain a digital object. The I Block 60 is entitled “Product Data,” the O Block 62 is omitted (because it is optional), the P Block 66 is entitled “Sales Associate” and the R Block 68 is entitled “Consumer.”

### Case Lifecycle

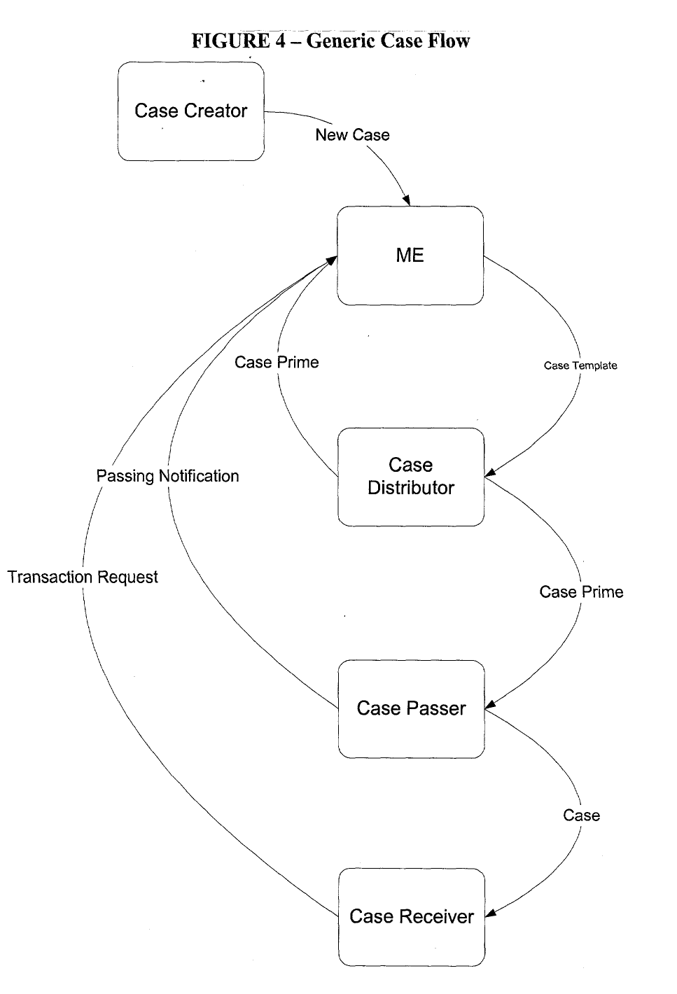

The layout and contents of a case evolve over the course of a lifecycle 80, as shown in FIG. 4. The case lifecycle 80 is summarized in the following description. Throughout this discussion, applications software acting on behalf of one of the various parties is referred to by the name of that party, i.e., Producer 34, ME 38, Distributor, Passer and Receiver.

### New Case Creation

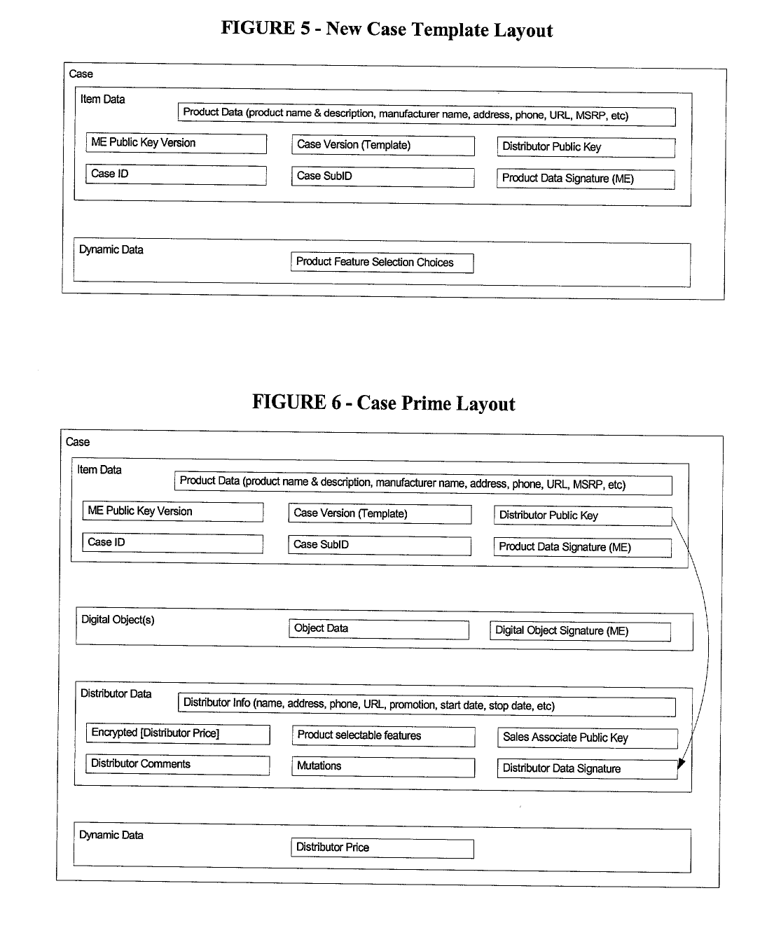

A newly created case template is depicted in FIG. 5. The Case Creator inserts Item Information (“Product Data”) and the Distributor Public Key into the I Block 60. If the case is related to other cases, e.g., for inheritance of case properties, the Case Creator inserts the appropriate Link Information. The Distributor Public Key is either that for a specific Distributor or it is a randomly selected public key. The latter requires the case template to also include the corresponding “private” key in Dynamic Data for use by any Distributor receiving the case. If the case will convey digital content the Case Creator inserts Object Information and the Object itself into the O Block 62 (not shown in FIG. 5). The Case Creator then forwards the case to the ME 38 for signing, as depicted in FIG. 4.

### Case Template

The ME 38 automatically or manually inserts Case Information (Case ID, Case SubID and Case Version) and the ME 38 Public Key (Version) into the I Block 60, then signs the I Block 60 and the O Block 62 (if present). The resulting case template is as depicted in FIG. 5 (without an O Block 62). The ME 38 forwards the case template to the Distributor.

### Case Prime

The Distributor inserts Distributor Information, Item Information (Encrypted Distributor Price and Distributor Comments), Item Options (Product Selectable Features), Mutation Rules (Mutations) and the Passer Public Key (Sales Associate Public Key) into the D Block 64 and signs it. The Distributor inserts optional Dynamic Data (e.g., Distributor Price and Sales Associate Private Key if the Passer Public Key was randomly selected) to complete the case prime. The Distributor can also insert an object into an O Block 62 then have the ME 38 sign it. The resulting case prime, depicted in FIG. 6, is made available to the Passer whose public key is in the Passer Public Key field. If a randomly selected public key is placed in that field any Passer can obtain the case and pass it to others. A copy of the case prime is provided to the ME 38 to be maintained in a global case registry.

### Case Passing

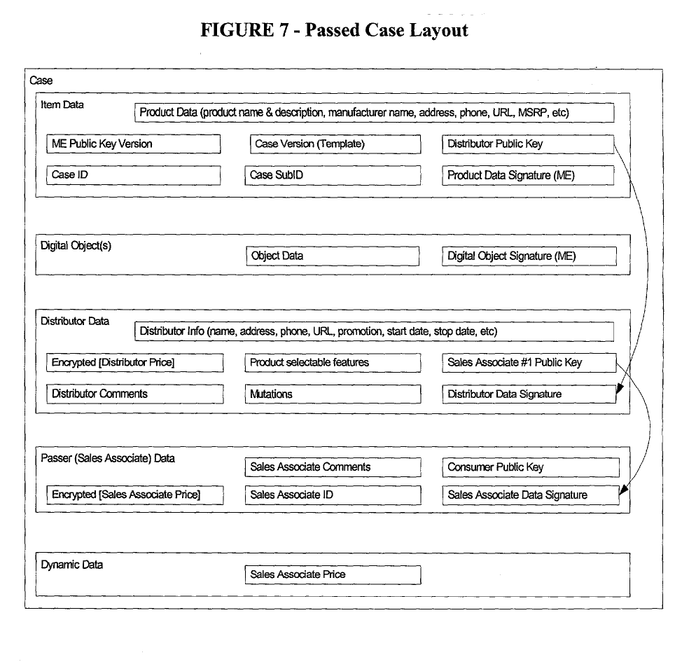

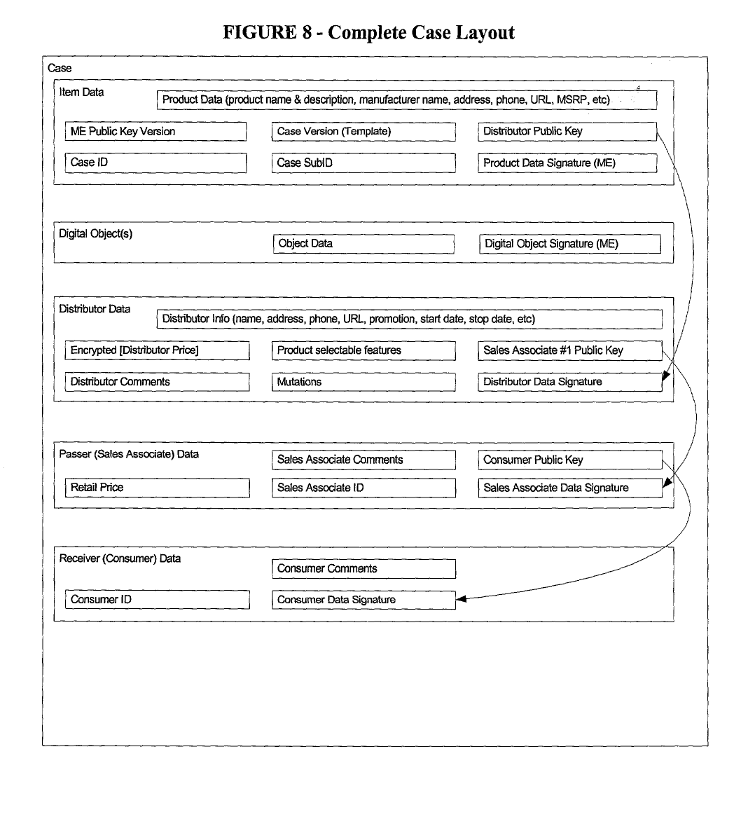

The Passer inserts Passer Information (Sales Associate ID), Item Information (Encrypted Sales Associate Price and Sales Associate Comments) and Receiver Public Key (Consumer Public Key) into the P Block 66 (Sales Associate) and signs it. The Passer inserts Dynamic Data (Sales Associate Price and Consumer Private Key if the Receiver Public Key was randomly selected) to complete the passed case, as depicted in FIG. 7. The case may be passed multiple times with specific information recorded for tracking purposes, as described below. If a randomly selected public key is placed in the Receiver Public Key field any Receiver can obtain the case and pass it to others. A complete passed case is depicted in FIG. 8.

### Passing Notification.

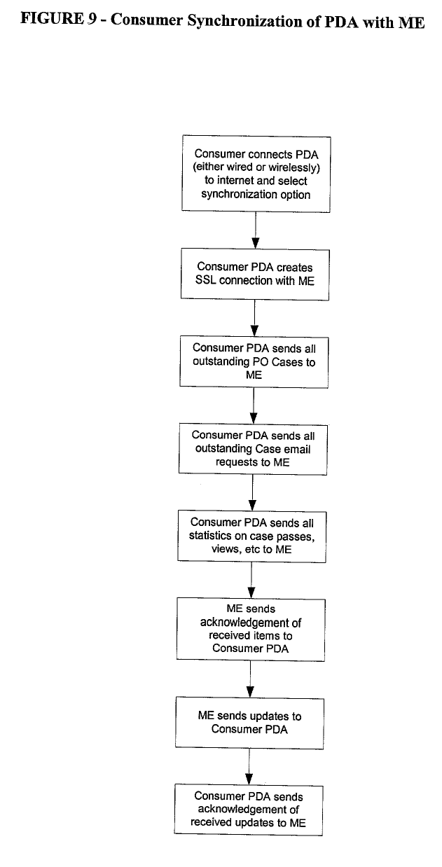

As the case is passed, notifications can be sent to the ME 38. One exemplary process of notifying the ME 38 is illustrated in FIG. 9, in which a Consumer's PDA is synchronized with the ME 38. First, at block 100, consumer connects PDA (either wired or wirelessly) to internet and select synchronization option. At block 102, Consumer PDA creates a SSL connection with the ME 38. At block 104, Consumer PDA sends all outstanding PO Cases to ME 38. At block 106, Consumer PDA sends all outstanding Case e-mail requests to ME 38. At block 108, Consumer PDA sends all statistics on case passes, views, etc. to ME 38. At block 110, ME 38 sends acknowledgement of received items to Consumer PDA. At block 112, ME 38 sends updates to Consumer PDA. At block 114, Consumer PDA sends acknowledgment of received updates to ME 38.

### Purchase Request

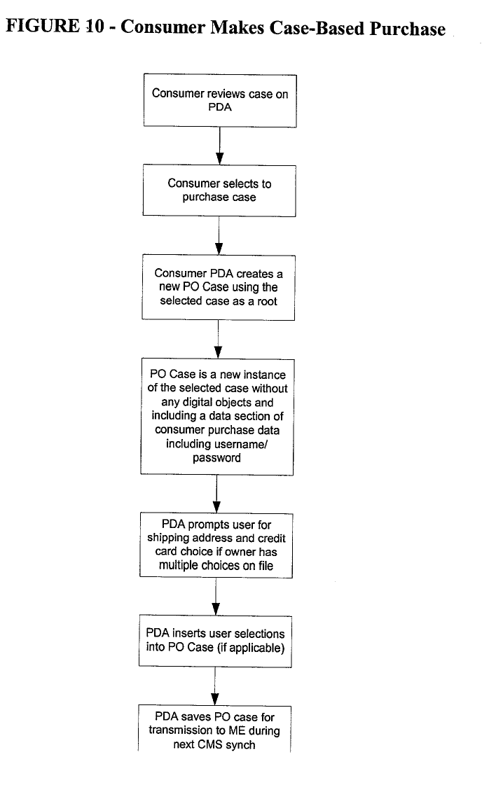

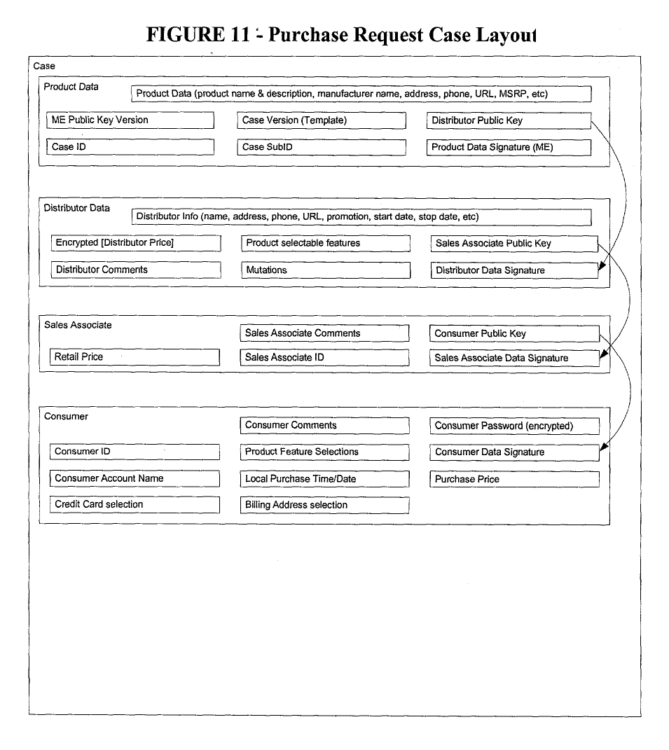

The passed case may be used by the Receiver to initiate a purchase request as depicted in FIG. 10. The purchase request itself is illustrated in FIG. 11. As shown in FIG. 10, at block 150 Consumer reviews case on PDA. At block 152, Consumer selects to purchase case. At block 154, Consumer PDA creates a new PO Case using the selected case as a root. At block 156, PO Case is a new instance of the selected case without any digital objects and including a data section of consumer purchase data including username/password. At block 158, PDA prompts user for shipping address and credit card choice if owner has multiple choices on file. At block 160, PDA inserts user selections into PO Case (if applicable). At block 162, PDA saves PO Case for transmission to ME 38 during next CMS synch.

### Case Passing

When a case is passed between parties, it is not deleted from the first party (although it may be deleted later). The case is copied then updated to reflect its passage from one party to the next. This modified case is what is passed to the receiving party. At that point, each of the passing and receiving parties are in possession of nearly identical cases.

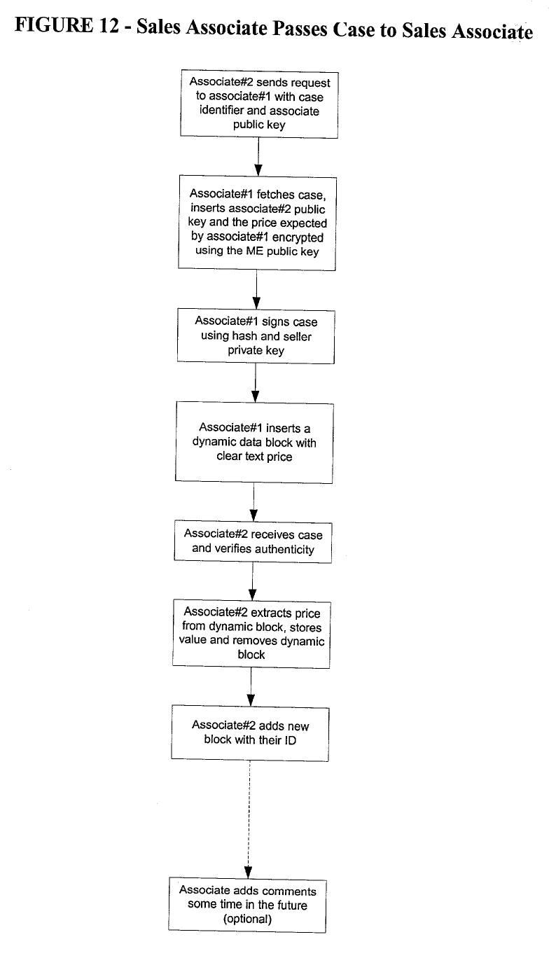

In a pervasive commerce setting, there are three basic scenarios for case passing—1) between sales associates, 2) between consumers and 3) from a sales associate to a consumer. The primary difference between a sales associate and a consumer is that a sales associate makes a commission from passing a case to someone who subsequently purchases an item from the case, whereas a consumer is not necessarily financially motivated to pass cases. Thus, some additional information elements must be maintained in scenarios involving sales associates. The three basic scenarios for case passing are illustrated in FIGS. 12-14.

In FIG. 12, at block 180, associate #2 sends a request to associate #1 with case identifier and associate public key. At block 182, associate #1 fetches a case, inserts associate #2 public key and the price expected by associate #1 that is encrypted using the ME 38 public key. At block 184, associate #1 signs the case using hash and seller private key. At block 186, associate #1 inserts a dynamic data block with clear text price. At block 188, associate #2 receives the case and verifies authenticity. At block 190, associate #2 extracts price from dynamic block, stores value and removes dynamic block. At block 192, associate #2 adds new block with their ID. At block 196, associate adds comments some time in the future (optional).

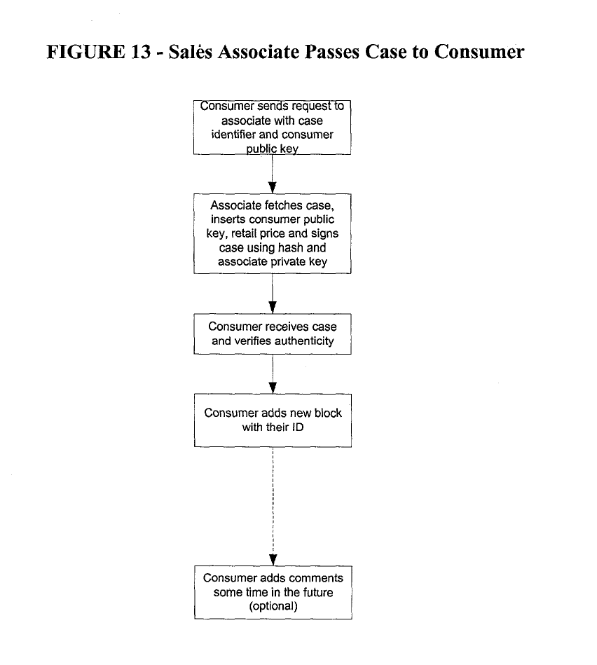

In FIG. 13, at block 210 consumer sends request to associate with case identifier and consumer public key. At block 212, associate fetches case, inserts consumer public key, retail price and signs case using hash and associate private key. At block 214, consumer receives case and verifies authenticity. At block 216, consumer adds new block with their ID. At block 220, consumer adds comments some time in the future (optional).

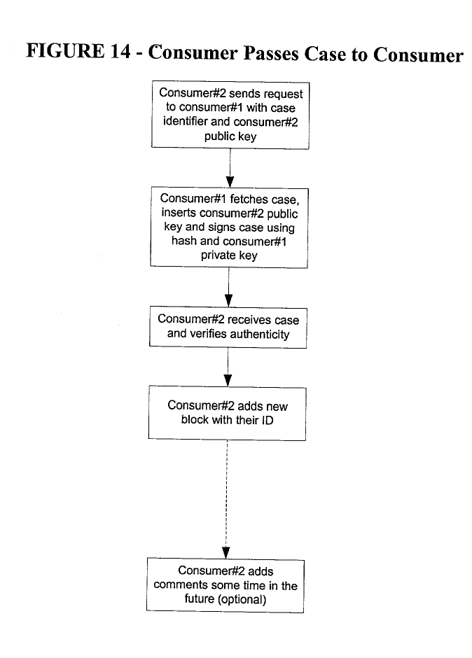

In FIG. 14, at block 250, consumer #2 sends request to consumer #1 with case identifier and consumer #2 public key. At block 252, consumer #1 fetches case, inserts consumer #2 public key and signs case using hash and consumer #1 private key. At block 254 consumer #2 receives case and verifies authenticity. At block 256, consumer #2 adds new block with their ID. At block 260, consumer #2 adds comments some time in the future (optional).

Since different applications have different needs in the amount of data and history tracked by the case, the integrity of the case tracking data and the memory and computational requirements necessary to exchange and manage the case, the case passing procedure can vary for different applications to optimize the parameters of interest to that application.

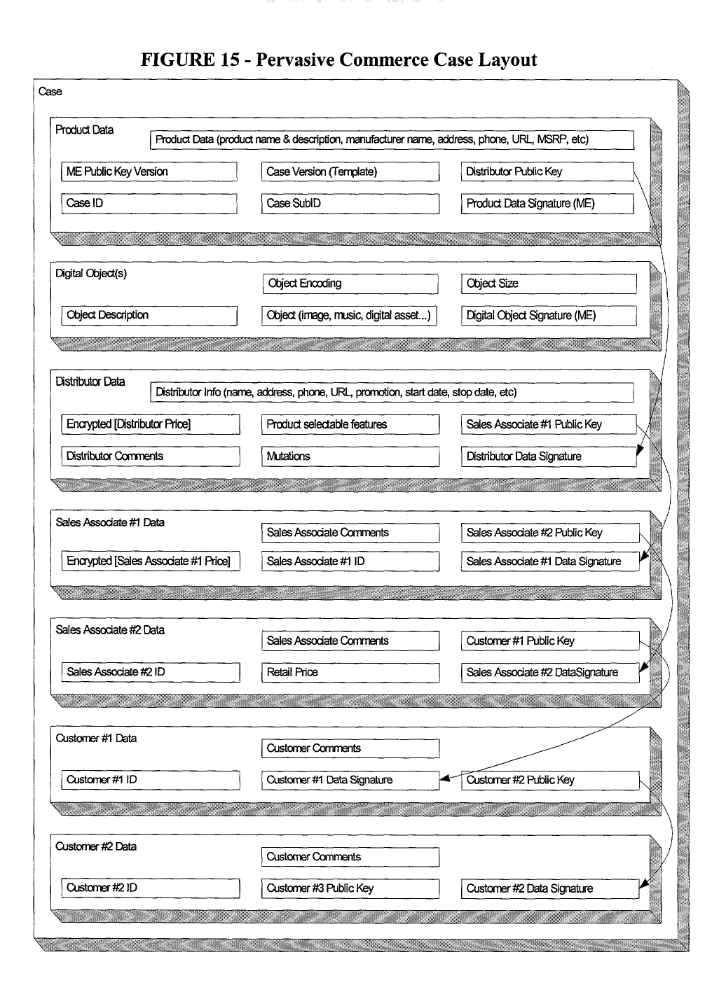

The case passing procedure described thus far is an all-encompassing procedure where the case contains secure information about each entity that has been in possession of the case. This case passing procedure provides maximum case tracking information and information integrity at the expense of case size and application processing requirements. Since each person that passes the case adds data fields to the case, the size of the case could theoretically grow without bounds, as depicted in FIG. 15. To counter this drawback for situations where case size is important three alternative case passing methods are now described.

The most compact method of case passing is to allow only one additional block of user information following the D Block 64. This additional block contains any variable information such as mutations, price, last person's comments, and the last person's signature. Key exchange and signature mechanisms remain the same as that described earlier. Whenever a Receiver acquires a new case, they replace the last block in the case with one pertaining to the Receiver and ship the replaced block to the ME 38 during the next synchronization. The ME 38 receives each of these replaced blocks and constructs a distribution tree for that case, verifying the flow of digital signatures at each branch.

This compact case passing method minimizes case size and maintains case integrity but requires the ME 38 to verify case integrity. Regardless of whether or not the integrity of a case has been breached, the case could become widely distributed. Should an invalid case become widespread, the ME 38 would have to reject transactions involving that case, leading to inferior customer experiences. Further, consumer transactions involving a case must wait until the ME 38 is able to validate the case, i.e., the transaction is suspended until everyone that handled the case earlier has synchronized with the ME 38.

Another case passing method includes a compromise between the preceding mechanisms, which limits the number of data blocks in a case for sales associates and consumers. Once the limit has been reached the case is invalid and cannot be passed again until the user possessing the case synchronizes with the ME 38. During synchronization the ME 38 extracts superfluous data blocks from the case and updates/re-signs the Item Data block to point to the next block in the chain. This technique requires the ME 38 synchronization to take place in real time or, alternatively, the user could send the case to the ME 38 during the first synchronization then receive an updated case during a subsequent synchronization.

The final case passing mechanism involves truncating cases whenever users synchronize with the ME 38. This is advantageous in that case passing will rarely be suspended because a case has exceeded size limits. However, this technique involves a realtime transaction with the ME 38. Further, the synchronization time can become excessive if many tens or hundreds of cases need to be sent back, truncated and returned during each synchronization event.

The alternatives described are meant to be exemplary not exhaustive. Many additional alternatives can be derived from the concepts explained to create a technique that is optimum for most applications of cases.

### Case Integrity and Confidentiality

In order to prevent the creation and distribution of unauthorized and invalid cases the case data structure provides data are integrity by means of digital signatures. Cases independently signed blocks of data contributed by various distributed parties. The digital signatures of the blocks are linked in a fashion similar to a linked list, as depicted in FIG. 3 and FIGS. 6-8. The ME 38 signs the I Block 60 containing the public key of the appropriate Distributor that distributes the case. Likewise, the D Block 64 containing the public key of the Passer is signed by the Distributor.

When a Receiver wants to verify the authenticity of a case, the only required piece of external data is the ME 38 public key. Using this key, the Receiver can verify the authenticity of the I Block 60. Once this block has been verified to have remained unmodified, the contained Distributor public key can be extracted and used to authenticate the D Block 64. This verification chain can continue as necessary to verify all blocks of interest to the Receiver of the case.

This chaining provides two key benefits. First, if each block were signed individually without any linking between blocks, any user could replace previously inserted blocks with fraudulent blocks that they created and signed using a randomly generated key pair. Second, everyone who receives a case has the ability to authenticate every block within the case while only having to store the public key of the ME 38. Since each block contains a signed version of the public key to verify the next block, all of the public keys, except one, are contained within the case data structure, thus avoiding a significant key management issue.

As a case passes through its lifetime, as depicted in FIG. 4, certain data fields that should only be viewed by the ME 38 are inserted. To prevent these data fields from being viewed by subsequent Receivers, these data fields remain confidential through encryption, such as PKI. These fields are encrypted using the ME 38 public key and when the case is received by the ME 38 in the form of a purchase request, the ME 38 decrypts these fields using its private key. Alternatively, these fields could be encrypted using a special Case Public Key included within the I Block 60. This second encryption key alternative requires the ME 38 to generate and manage private/public key pairs for each case. However, the benefit is a reduced risk of compromise of the ME 38 private key.

The techniques described for maintaining case integrity impose several additional requirements upon the exchange of cases between Passers and Receivers. Since each block of the case must contain the public key of the next entity in the chain and be signed by the most recent entity in the chain, a certain amount of handshaking is required to pass a case.

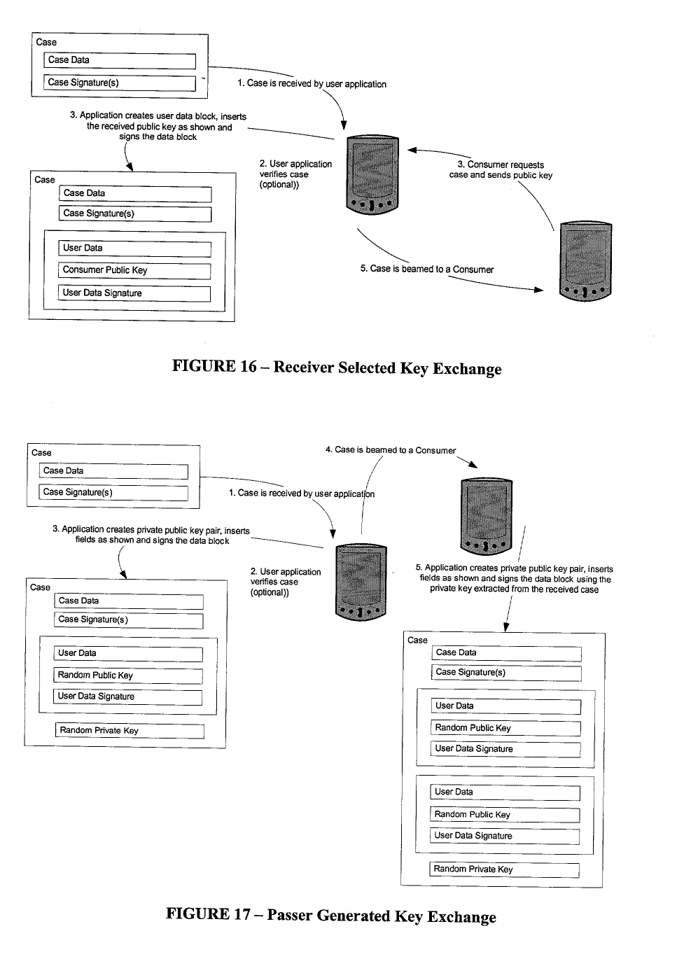

The standard procedure for case passing is shown in FIG. 16. If a Receiver wants to receive a case from the Passer, the Receiver must first provide a copy of its public key to the Passer. It is worth noting that if these two entities exchange cases regularly, the Passer may already have this key on file. Once the Passer is aware of which case is desired by the Receiver and is in possession of the appropriate key, the Passer creates a new version of the desired case and inserts the Receiver's public key. Next, the Passer signs its block of the case using the Passer's private key. Once the case has been prepared, the case is transmitted to the Receiver. The Receiver can verify the integrity of the case by verifying each of the digital signatures in the chain.

Due to the need for communication handshaking and real time data processing to compute and sign a digital signature, an alterative mechanism is described that necessitates minor security compromises in return for significantly reducing the amount of real time computation and communications hand-shaking. This alternate procedure is described in FIG. 17. In this scenario, the Passer generates a random public/private key pair upon receiving the case. The public key is inserted into the Passer's data block and the block is signed using the Passers private key. The random private key is inserted into a dynamic data block that is not signed. When a Receiver requests a case, the Passer just transmits the case to the Receiver. The Receiver then extracts the private key from the dynamic data block and uses this as the private key for signing the block that they create.

While this technique greatly simplifies the case passing process, it does introduce a security hole. Since the Passer generated the private key for the Receiver, the possibility exists for the Passer to acquire the case at a later date and tamper with the block signed by the Receiver. For this reason this case passing approach should only be utilized for blocks that do not contain critical data fields. A good example would be using this technique for case passes to and between consumers. The only important data entered by the consumer is their comments. While it would be preferable to prevent hackers from altering ones personal comments, extreme measures are not really justified. Commercial fraud can be prevented by means of the Receiver using their own private key to protect purchase requests.

### Digital Object

One of the optional information elements of the case is the digital object, contained within the O Block 62. The digital object can be anything that is represented digitally in a standard format recognized by the applications that exchange and utilize cases. This flexibility in the contents of the digital object leads to the overall flexibility in utilization of the case for multiple applications and purposes.

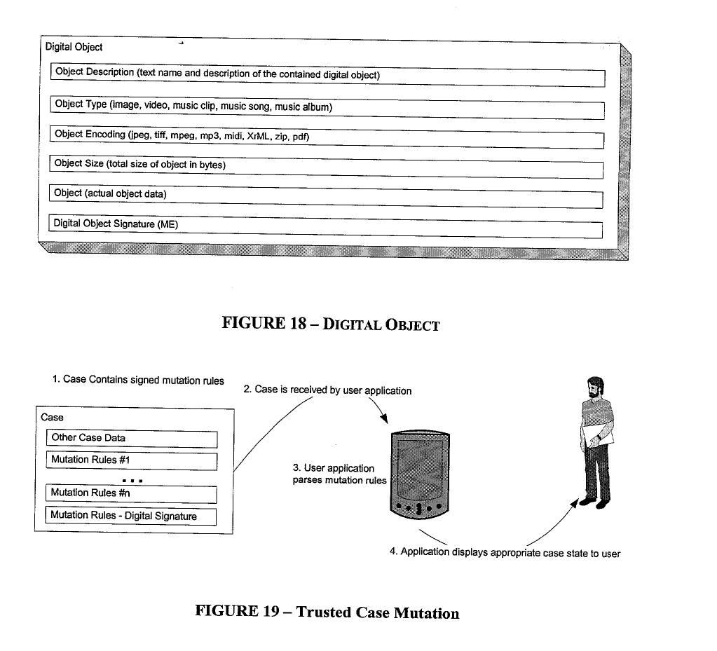

In order to provide this flexibility, the digital object must be a completely self-contained and self-descriptive package. FIG. 18 depicts a potential structure for the digital object. Each object can optionally include a name and description. Each object must be described by an object type and encoding, which is sufficiently descriptive to allow the receiving application to decode and display/play the object. These parameters must be based upon recognized industry standards, such as MIME 38 (RFC1521 & RFC1522). The actual digital object must be preceded by a declaration of the size (in bytes) of the object. Finally, the digital object can optionally contain a digital signature. Such a signature is created by the ME 38 and encrypted using a private key from the ME 38 whose matching public key has been distributed with the applications used to manage and exchange cases. In this way each application has the tools and capabilities to verify the digital object.

As is shown in FIG. 18, digital objects can represent images, video, audio, books, fax, documents, software or any other of a wide variety of media that can be represented digitally. In addition to containing media for free and unlimited use and distribution by anyone that possesses the digital object, digital objects can also be digital assets. In situations where the digital object is a digital asset, the embedded object will typically be encrypted and encased within a separate digital rights management (DRM) header. The DRM header contains information such as usage rights, reproduction rights, printing rights, usage costs and/or product costs as applicable. This DRM header can be represented in a number of formats; for example, XrML is a DRM schema creating using XML. From the perspective of the case, the digital object information must have a sufficient description of the enclosed DRM header for the receiving application to decode and render/use.

### Case Mutation

Mutation is the ability of the case to change throughout its instantiation. If a case is an advertisement/coupon for a product, a desirable mutation might be a promotion that changes with time or the number of passes. Likewise, if the case is a flyer for a free concert the case might invalidate itself once the concert date has passed. Depending upon the nature of the application the desired mechanism for case mutation can vary.

Mutation can be desirable for fields that are either trusted or untrusted. For trusted field mutations, the mechanism is depicted in FIG. 19. When a case is created, mutation rules are added to the D Block 64 by the Distributor of the subject item. Since these rules are signed, future users of the case verify this signature and are confident that the mutation rules have not been modified. When an application receives a case that contains mutation rules, the application parses these rules and compares them against the state of the case. Examples of case state could be absolute date/time or number of passes. Using the mutation rules and case state, the application selects the information to be displayed to the user.

The following list demonstrates some examples of case state variable that might be used in conjunction with mutation rules:

Absolute date

Absolute time

Number of passes

Number of case copies

Relative time/date (length of case possession)

Location of case (based upon location data received from an access point)

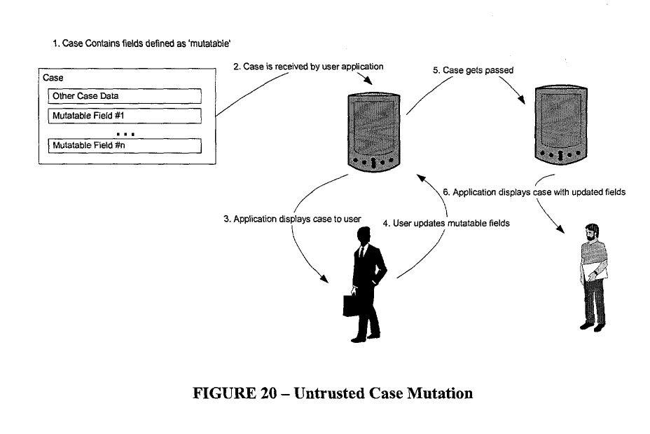

When the fields that are to be mutated do not need to be trusted, a more flexible mechanism can be used for field mutation as shown in FIG. 20. In this scenario, the case contains appropriately designated mutatable fields. In order to allow uncontrolled mutations of these fields, no digital signatures should be made using digests containing these fields. When a user receives such a case, the user knows that they have authority to change these fields. A practical application for such a mutatable field would be a comments field for a product/coupon case. Each user that receives the case has the authority to read other's comments and insert their own comments. However, because these fields are untrusted, the case provides no mechanisms to protect a future holder of the case from modifying previous comments.

While the preferred embodiment of the invention has been illustrated and described, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A computer program product comprising:
a case creation component for creating, at a creator system, a case by inserting item information and a distributor public key into a first block, wherein the distributor public key is at least one of a specific distributor or a randomly selected public key, and if the case is to include digital content, inserting digital object information and a digital object into a second block;
a case information component for inserting, at a managing system coupled to the creator system over a network, case information and a managing system public key into the first block of the created case and signing the first block and second block, if present in the case;
a case prime component for inserting, at a distributor system coupled to the managing system over the network, distributor information, item information, item options, mutation rules and a passer public key into a third block in the case, and signing the third block;
a case receiving component for receiving at a station unit a case from at least one of the distributor system or managing system over the network;
a case passing and purchase component for at least one of retrieving a case from a first station unit to a second station unit or receiving a case at a second station unit from a first station unit and selecting the retrieved or received case, for inserting at the first station unit, item information, and a receiver public key into a fourth block in the case, and signing the fourth block, and creating a new case using the selected case as a root, wherein the new case comprises a data section of consumer purchase data, and wherein the first and second station unit are disconnected from the network; and
a passing notification component for sending a notification from the station unit to the managing system over the network after the station unit has passed a case to another station unit and when the station unit has been recoupled to the managing system over the network.

2. The product of claim 1, wherein the passing notification component comprises a commission component for applying a commission to a user account associated with a station unit that passes a case to another station unit, whereby the user associated with the receiving station unit subsequently purchases an item associated with the passed case,
wherein the passing station unit is associated with a user that was previously designated a sales associates.

3. The product of claim 1, wherein the station units are associated with consumers.

4. The product of claim 1, wherein the case creation component inserts link information, if a created case is to inherit properties from one or more other created cases.

5. The product of claim 1, wherein the item information comprises encrypted distributor price information and distributor comments.

6. The product of claim 1, wherein the item information identifies a physical item.

7. The product of claim 1, wherein the mutation rules define how the case can be mutated.

8. The product of claim 7, wherein the mutation rules comprise at least one of time limit or a number of passes limit.

9. The product of claim 1, wherein the item options comprise selectable features of an associated product.

10. The product of claim 1, wherein the case prime component further inserts dynamic data.

11. The product of claim 10, wherein the dynamic data comprises distributor price and sales associate private key, if the passer public key was randomly selected.

12. The product of claim 1, wherein the case prime component further inserts an object into the third block and sends the case to the managing system for signing.

13. The product of claim 1, wherein the passing notification component sends all unprocessed cases to the managing system.

14. The product of claim 1, wherein the case information component automatically inserts the case information and the managing system public key.

15. The product of claim 1, wherein the digital object comprises one or more of a digital recording of music, images, or video.

16. A commerce system comprising:
a plurality of retailer systems coupled to a network;
a plurality of manufacturer systems coupled to the network;
a plurality of access point systems coupled to the network;
a managing system coupled to the a plurality of retailer systems, manufacturer systems, and access point systems over the network, the managing system comprising:
memory configured to store member information, and
a processor coupled to the memory;
a plurality of station units, each station unit comprising:
memory;
a user interface;
a transmitter/receiver configured to control wireless data transmission and reception to and from other station units and wireless and hardwired data transmission and reception to and from one of the plurality of access points; and
a processor coupled to the memory, the user interface and the transmitter/receiver; and
a computer program product comprising:
a case creation component for creating, at one of the manufacturer systems a case by inserting item information and a retailer public key into a first block, wherein the retailer public key is at least one of a specific retailer or a randomly selected public key, and if the case is to include digital content, inserting digital object information and a digital object into a second block;
a case information component for inserting at the managing system case information and a managing system public key into the first block of the created case and signing the first block and second block, if present in the case;
a case prime component for inserting at one of the retailer systems retailer information, item information, item options, mutation rules and a passer public key into a third block in the case, and signing the third block;
a case receiving component for receiving a case at one of the station units via one of the access point systems from at least one of the retailer system or managing system over the network;
a case passing and purchase component for at least one of retrieving a case from a first station unit to a second station unit or receiving a case at a second station unit from a first station unit and selecting the retrieved or received case, for inserting at the first station unit, item information, and a receiver public key into a fourth block in the case, and signing the fourth block, and creating a new case using the selected case as a root, wherein the new case comprises a data section of consumer purchase data, and wherein the first and second station unit are disconnected from the network; and
a passing notification component for sending a notification from a station unit to the managing system over the network after the station unit has passed a case to another station unit and when the station unit has been recoupled to the managing system over the network.

17. The system of claim 16, wherein the passing notification component comprises a commission component for applying a commission to a user account associated with a station unit that passes a case to another station unit, whereby the user associated with the receiving station unit subsequently purchases an item associated with the passed case, wherein the passing station unit is associated with a user that was previously designated a sales associates.

18. The system of claim 16, wherein the station units are associated with consumers.

19. The system of claim 16, wherein the case creation component inserts link information, if a created case is to inherit properties from one or more other created cases.

20. The system of claim 16, wherein the item information comprises encrypted distributor price information and distributor comments.

21. The system of claim 16, wherein the item information identifies a physical item.

22. The system of claim 16, wherein the mutation rules define how the case can be mutated.

23. The system of claim 22, wherein the mutation rules comprise at least one of time limit or a number of passes limit.

24. The system of claim 16, wherein the item options comprise selectable features of an associated product.

25. The system of claim 16, wherein the case prime component further inserts dynamic data.

26. The system of claim 25, wherein the dynamic data comprises distributor price and sales associate private key, if the passer public key was randomly selected.

27. The system of claim 16, wherein the case prime component further inserts an object into the third block and sends the case to the managing system for signing.

28. The system of claim 16, wherein the passing notification component sends all unprocessed cases to the managing system.

29. The system of claim 16, wherein the case information component automatically inserts the case information and the managing system public key.

30. The system of claim 16, wherein the digital object comprises one or more of a digital recording of music, images, or video.
